(19) United States
(12) Patent Application Publication
(10) Pub. No.: US 2026/0018626 A1
(43) Pub. Date: Jan. 15, 2026

(54) FUEL CELL STACK

(71) Applicant: POWERCELL SWEDEN AB, 41 834 Gothenburg (SE)

(72) Inventor: Oskar EKBLAD, Gothenburg (SE)

(73) Assignee: POWERCELL SWEDEN AB, 41 834 Gothenburg (SE)

(21) Appl. No.: 18/994,299

(22) PCT Filed: Jul. 5, 2023
(86) PCT No.: PCT/SE2023/050704

§ 371 Date: Jan. 14, 2025

(30) Foreign Application Priority Data
Aug. 3, 2022 (SE) 2250947-5

(51) Int. Cl. H01M 8/0258; H01M 8/0276; H01M 8/2475

(52) U.S. Cl. CPC H01M 8/0258; H01M 8/0278; H01M 8/2475

(57) ABSTRACT

A fuel cell stack includes at least a fuel cell stack body with a plurality of unit fuel cells, wherein each unit fuel cell includes a bipolar plate and a membrane electrode assembly, which are alternatingly stacked in a stacking direction, a first and second terminal plate sandwiching the fuel cell stack body, wherein the first and second terminal plate are adapted to collect the electric energy generated by the fuel cell stack body, a first insulation plate and a second insulation plate sandwiching the terminal plates, wherein the insulation plates are adapted to electrically insulate the terminal plates, and a first and second end plate sandwiching the insulation plates, wherein at least one first sealing element is arranged between at least one insulation plate and the adjacent end plate.

### BACKGROUND AND SUMMARY

The present invention relates to a fuel cell stack.

Usually, a fuel cell stack comprises a stack body including a plurality of membrane electrode assemblies (MEAs), which are separated by so called bipolar plates (BPP), a pair of terminal plates collecting the electric current produced by the stack body, and a pair of endplates sandwiching the terminal plates. To insulate each terminal plate from the adjacent endplate, an insulation plate is provided between each of the terminal plate and the adjacent endplate.

The bipolar plates themselves usually comprise at least two electrically conducting metal plates, so called flow field plates, which are placed on top of each other and have a flow field for the reactants at one side and a flow field for a cooling fluid on the other side. Thereby, the cooling fluid flow fields are facing each other, wherein the reactant fluid flow fields face the MEAs. Each bipolar plate and/or membrane electrode assembly comprises a fuel, oxidant, and coolant inlet manifold, and a fuel, oxidant, and coolant outlet manifold. In the assembled stack, each of the manifold forms a tubelike channel, which extends through the fuel cell stack body and conveys the respective streams to and from the fuel cell stack. The flow field of each plate forms an active area in which electric energy is generated, wherein the active area is disposed between the inlet and outlet manifolds of each unit fuel cell.

To provide touch protection and/or protection from environmental influences like water and/or dirt, the fuel cell stack is enclosed in a housing which comprises a bottom plate, a top plate, as well as side walls, wherein sealing elements may be provided between the different elements of the housing to achieve a hermetically sealed environment for the fuel cell stack within the housing that ensures a safe an stabile operation of the fuel cell stack. Usually this is ensured by narrow tolerances that define any positions and/or seats for the employed sealing elements.

However, due to the necessary precision that is required in the manufacturing of the stack components in order to ensure a hermetic sealing of the fuel cell stack and the number of components that are included in the fuel cell stack, the manufacture and the assembly of the fuel cell stack can be costly and work intensive.

It is desirable to provide a fuel cell stack which has an improved sealing, and which can be assembled in an easy and efficient manner.

In the following, a fuel cell stack is provided that comprises a fuel cell stack body with a plurality of unit fuel cells. Each unit fuel cell comprises a bipolar plate and a membrane electrode assembly, which are alternatingly stacked in a stacking direction, wherein each bipolar plate and/or membrane electrode assembly may comprise at least fuel, oxidant, and coolant inlet manifolds, and at least fuel, oxidant, and coolant outlet manifolds. The manifolds may form respective tubelike channels extending through the fuel cell stack body for providing the respective streams to and from the fuel cell stack, wherein the each of the unit fuel cells has an active area in which electric energy is generated, wherein the active area is disposed between the inlet and outlet manifolds of each unit fuel cell.

The fuel cell stack further includes a first and second terminal plate sandwiching the fuel cell stack body, wherein the first and second terminal plate are adapted to collect the electric energy generated by the fuel cell stack body. Also, the fuel cell stack comprises a first and second end plate which sandwich the fuel cell stack body, wherein at least one end plate may comprise at least one inlet opening and at least one outlet opening, wherein the at least one inlet opening is aligned with one or more of the inlet channels, and the at least one outlet opening is aligned with one or more of the outlet channels.

Moreover, the fuel cell stack comprises a first insulation plate arranged between the first end plate and the first terminal plate, and a second insulation plate arranged between the second end plate and the second terminal plate, wherein the insulation plates are adapted to electrically insulate the terminal plates from the end plates. At least one of the insulation plates may comprise at least fuel, oxidant, and coolant inlet ducts, and at least fuel, oxidant, and coolant outlet ducts which are adapted to fluidly connect the channels to the at least one inlet opening and the at least one outlet opening. Preferably, the inlet ducts and the outlet ducts may extend into the at least one inlet opening and the at least one outlet opening, respectively. For example, each duct may comprise a projection that extends into the opening of the at least one end plate. Furthermore, the ducts may also be adapted to be connected to respective supply lines for fuel, oxidant, and coolant.

In order to provide a fuel cell stack that has a sufficient sealing to the outside and can be assembled in an easy and efficient manner at least one first sealing element is arranged between at least one insulation plate and the adjacent end plate. Preferably, the at least one first sealing element is arranged such that an ingression of a fluid in a space between the at least one insulation plate and the adjacent end plate from an outside of the fuel cell stack is prevented. Advantageously, the at least one first sealing element may be arranged at a surface of the at least one end plate facing the associated insulation plate such that a seal can be easily formed by compressing the at least one sealing element in the stacking direction. As the fuel cell stack is usually compressed in the stacking direction both during assembly and in its assembled state, there is no need for a precise positioning of the components between which the at least one first sealing element is positioned to ensure a sufficient seal.

According to a further embodiment, at least one end plate comprises at least one inlet opening and/or at least one outlet opening for supplying reactant and/or coolant to and/or from the fuel cell body, wherein the at least one first sealing element extents around a perimeter of the at least one inlet opening and/or at least one outlet opening. More particularly, the at least one first sealing element may extend around the entire perimeter of the at least one opening. Also, the at least one first sealing element may surround the at least one opening on a surface that has a surface normal that is parallel with the stacking direction. This allows to efficiently seal the fuel cell stack against water, dirt and/or other fluids and/or particles that may enter the fuel cell stack form the outside.

Preferably, at least one of the insulation plates comprises fuel, oxidant, and coolant inlet ducts, and fuel, oxidant, and coolant outlet ducts, wherein the inlet ducts extend into one inlet opening and/or the outlet ducts extend into one outlet opening, and/or wherein the at least one end plate comprises an opening for each of the inlet ducts and/or outlet ducts of the insulation plate, wherein the inlet ducts and the outlet ducts extend into the respective openings, and wherein each opening is surrounded by a first sealing element. Thus, each opening in the end plate is protected by a sealing element.

Furthermore, the fuel cell stack may further comprise a housing, wherein the housing includes at least a bottom plate and a stack enclosure configured to cover the side faces of the fuel cell stack. The stack enclosure may be formed by a plurality of side walls that form a hollow box. In addition, the housing may also include a top plate. For example, one of the end plates may be adapted as the top plate. This reduces the number of components as well as the overall weight of the fuel cell stack. Alternatively, the stack enclosure also comprises a top wall.

Preferably, at least one second sealing element is arranged between the housing and at least one of the end plates. For example, the at least one second sealing element may be arranged between the stack enclosure and one of the end plates. This ensures a hermetic sealing of the housing and prevents any ingress of water, dirt, and/or other particles and/or fluids into the fuel cell stack. Alternatively or additionally, at least one second sealing element may extend around a perimeter of the at least one end plate.

According to a further embodiment, one of the end plates is further configured as the bottom plate of the housing. This allows to omit the bottom plate of the housing such that the overall fuel cell stack has less weight and less parts, which makes the assembly process simpler and the finished fuel cell stack lighter and saves costs. Advantageously, the second end plate may be further configured as a top plate of the housing. This reduces the number oof components and thereby the weight of the fuel cell stack even further.

Preferably, at least one of the end plates is provided with at least one flange, wherein the flange extends around a perimeter of the end plate. For example, the flange may provide a fastening interface for the housing for securing the housing on the end plate. The fastening interface may be a threaded hole in the flange such as a threaded through hole or a threaded blind hole or a through hole through which a fastening element can be passed.

According to a further embodiment, the at least one first sealing element is arranged at a surface of the at least one end plate facing the associated insulation plate and/or at a surface of the at least one insulation plate facing the end plate. Preferably, the at least first and/or second sealing element is fixed to the at least one end plate or the at least one insulation plate. By securing the at least one first and/or second sealing element to the at least one end plate or the at least one insulation plate the proper positioning of the at least one first and/or second sealing element can be ensured during the assembly process of the fuel cell stack, which allows for an improved sealing of the stack. Preferably, the at least first and/or second sealing element is arranged in a groove, is adhesively bonded, or injection molded. For example, the at least one sealing element may be a gasket or an O-ring.

Moreover, the at least one first and/or second sealing element may be an elastomeric element that is compressed in the stacking direction. This has the advantage that the sealing of the fuel cell stack is ensured just be gravity and/or a compression of the fuel cell stack. For example, the at least one first sealing element may be compressed by weight and/or by at least one compression element configured to provide an additional compression force on the fuel cell stack. The compression element may be compression bands that wrap around the fuel cell stack.

According to a further embodiment, the fuel cell stack includes at least one clamping element configured to apply additional force on the at least one insulation plate such that the at least one first sealing element is further compressed in the stacking direction. Preferably, the clamping element is fixed with at least one fastening element to the at least one end plate. For example, the fastening element may be a screw or bolt. The clamping element may be arranged such that at least a part of an edge of the insulation plate is clamped down. This ensures that the seal between the insulation plate and the end plate is maintained even if a compression of the fuel cell stack becomes loose, for example due to wear and/or breakage.

Further preferred embodiments are defined in the dependent claims as well as in the description and the figures. Thereby, elements described or shown in combination with other elements may be present alone or in combination with other elements without departing from the scope of protection.

In the following, preferred embodiments of the invention are described in relation to the drawings, wherein the drawings are exemplarily only, and are not intended to limit the scope of protection. The scope of protection is defined by the accompanied claims, only.

### BRIEF DESCRIPTION OF THE DRAWINGS

The figures show:

FIG. 1: a partial perspective explosion view of a fuel cell stack according to a first embodiment,

FIG. 2: a side view of the assembled fuel cell stack of FIG. 1,

FIG. 3: a detail III of FIG. 2,

FIG. 4: a perspective view of the fuel cell stack according to the first embodiment,

FIG. 5: a partial perspective view of a fuel cell stack according to a second embodiment, and

FIG. 6: a side view of the assembled fuel cell stack of FIG. 5.

### DETAILED DESCRIPTION

In the following same or similar functioning elements are indicated with the same reference numerals.

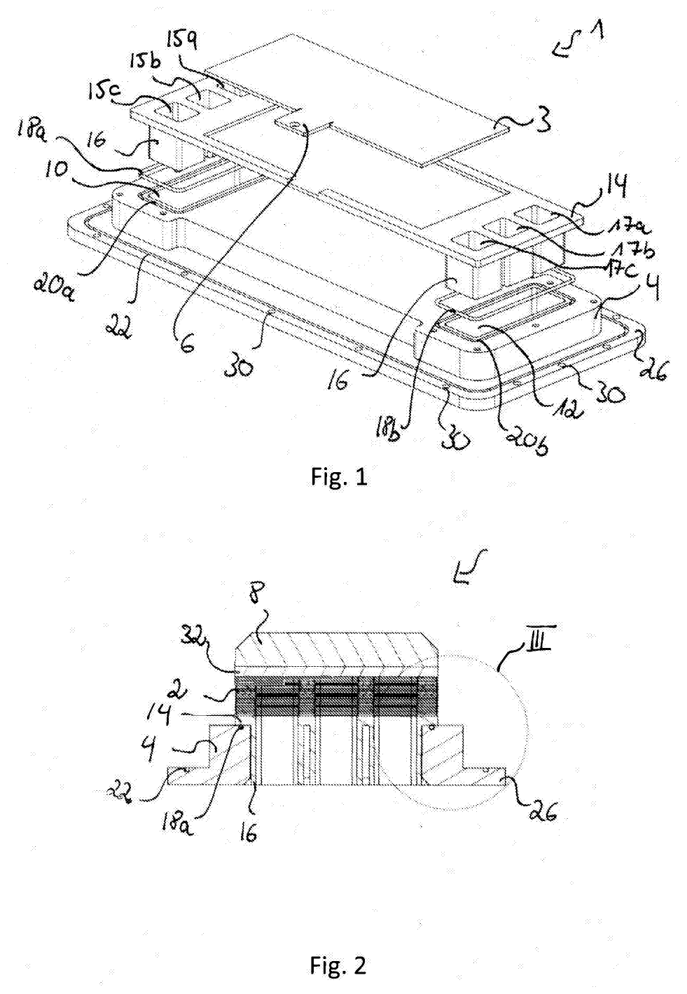

FIGS. 1 to 3 show a fuel cell stack 1 comprising a fuel cell stack body 2 (FIG. 2, 3) with a plurality of unit fuel cells and an end plate 4. Each unit fuel cell comprises a bipolar plate and a membrane electrode assembly, which are alternatingly stacked in a stacking direction such that two bipolar plates sandwich a multi-layer membrane electrode assembly. Each bipolar plate and/or membrane electrode assembly comprises three inlet manifolds (not shown), namely a fuel inlet manifold, an oxidant inlet manifold, and a coolant inlet manifold, and three outlet manifolds (not shown), namely a fuel outlet manifold, an oxidant outlet manifold, and a coolant outlet manifold, wherein the manifolds form respective tubelike channels which extend through the fuel cell stack 1 for providing the respective streams to and from the fuel cell stack 1. Each of the unit fuel cells has an active area in which electric energy is generated, wherein the active area is disposed between the inlet and outlet manifolds of each unit fuel cell.

For collecting and outputting the voltage, a first and a second terminal plate 3 are provided which sandwich the fuel cell stack body 2 in the active area. The first and second terminal plate 3 are adapted to collect the electric energy generated by the fuel cell stack 1, wherein each terminal plate 3 further comprises a power output terminal 6, which is connectable to an external connector.

Furthermore, the fuel cell stack 1 is sandwiched by a first end plate 4 and a second end plate 8 (FIG. 2), wherein the first end plate 4 comprises an inlet opening 10 and an outlet opening 12. The inlet opening 10 is aligned with the inlet channels, and the outlet opening 12 is aligned with the outlet channels. In the first embodiment shown in FIGS. 1 to 3, the second end plate 8 is configured to terminate the tubelike channels that are formed by the inlet manifolds and outlet manifolds such that a dead-end fuel cell is formed. However, it is also possible that the outlet openings may be provided at the second end plate 8. Alternatively, the end plate 4 may comprise an inlet opening for each of the inlet channels and an outlet opening for each of the outlet channels.

To insulate the fuel cell stack body 2 from the end plate 4, a first insulation plate 14 is arranged between the end plate 4 and the first terminal plate 3. Furthermore, a second insulation plate 32 (FIG. 2) may be arranged between the second end plate 8 and the second terminal plate. Both insulation plates 14, 32 are adapted to electrically insulate the terminal plates 3 from the end plates 4, 8. Furthermore, the first insulation plate 14 comprises a fuel, oxidant, and coolant inlet duct 15a, 15b, 15c, and a fuel, oxidant, and coolant outlet duct 17a, 17b, 17c which are adapted to fluidly connect the channels to the inlet opening 10 and the outlet opening 12. Each of the inlet and outlet ducts 15, 17 comprises a tubelike projection 16 that extends into the respective inlet opening 10 or outlet opening 12.

In order to seal the fuel cell stack 1 against the outside, a first sealing element 18a and a second sealing element 18b are arranged between the first insulation plate 14 and the end plate 4. The first sealing element 18a surrounds the inlet opening 10 of the end plate 4 and the second sealing element 18b surrounds outlet opening 12 of the end plate.

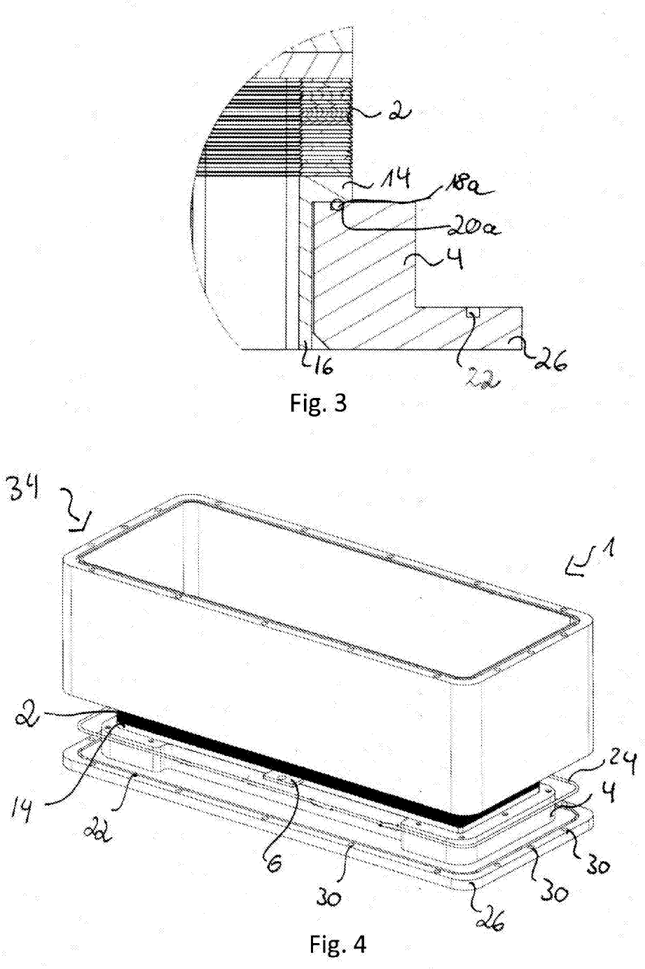

As can be seen from FIG. 3, the sealing elements 18a, 18b are arranged such that an ingression of a fluid in a space between the insulation plate 14 and the adjacent end plate 4 from an outside of the fuel cell stack can be prevented. Moreover, the sealing elements 18a, 18b are arranged at a surface of the end plate 4 which faces the insulation plate 14. This has the advantage that a tight sealing can be easily formed by compressing the sealing elements 18a, 18b in the stacking direction. As the fuel cell stack 1 is usually compressed in the stacking direction both during assembly and in its assembled state, there is no need for a precise positioning of the insulation plate 14 and the end plate 4 to ensure a sufficient seal. In a case, in which the end plate comprises an opening for each of the inlet ducts 15 and each of the outlet ducts 17, each opening may be surrounded by a sealing element.

As can be seen in FIG. 4, the end plate 4 is further configured as a bottom plate of a housing 34. This allows to omit an additional bottom plate for the housing 34 such that the overall fuel cell stack 1 has less weight and less parts. Furthermore, the end plate 4 is provided with a third sealing element 24 which extends around the perimeter of the end plate 4 and encompasses the inlet opening 10 and the outlet opening 12. Because the third sealing element 24 is arranged between the housing 34 and the end plate 4 a hermetic sealing of the housing 34 can be ensured and any ingress of water, dirt, and/or other particles and/or fluids into the fuel cell stack 1 can be prevented or at least reduced.

Moreover, the end plate 4 is provided with a flange 26, which extends around the perimeter of the end plate 4. The flange 26 has a plurality of fastening interfaces 30 for securing the housing on the end plate 4. For example, the fastening interface 30 may be a threaded hole in the flange such as a threaded through hole or a threaded blind hole or a through hole through which a fastening element can be passed.

The sealing elements 18a, 18b and the third sealing element 24 are fixed to the end plate 4 with the aid of respective grooves 20a, 20b and 22. By securing the sealing elements 18a, 18b, 24 to the end plate or, alternatively, to the insulation plate 14, the proper positioning of the sealing elements 18a, 18b, 24 can be ensured during the assembly process of the fuel cell stack 1, which allows for an improved sealing of the stack. Alternatively, the sealing elements 18a, 18b, 24 can also be adhesively bonded, or injection molded to the end plate 4 or the insulation plate 14.

Both the sealing elements 18a, 18b and the third sealing element 24 are an elastomeric element that is compressed in the stacking direction. This has the advantage that the sealing of the fuel cell stack 1 can be ensured just be gravity and/or a compression applied on the fuel cell stack 1 and/or a part of the fuel cell stack 1.

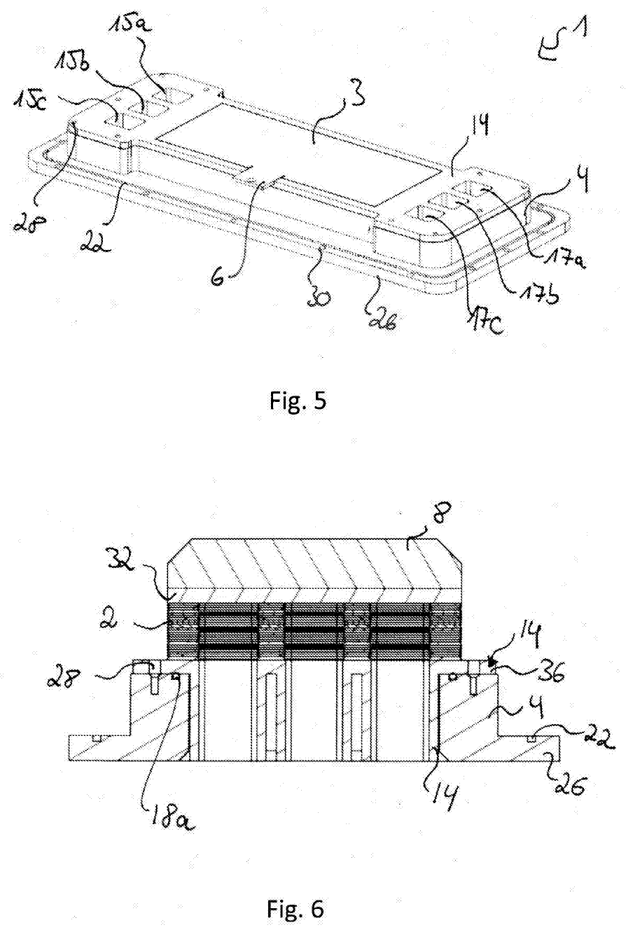

FIG. 5 shows a partial perspective view and FIG. 6 a side view of a fuel cell stack 1 according to a second embodiment. The fuel cell stack 1 of FIG. 1 and the fuel cell stack 1 of FIG. 2 differ in that the fuel cell stack 1 of FIG. 2 comprises a clamping element 28 configured to apply an additional force in the stacking direction on the insulation plate 14 and therefore on the first and second sealing element 18a, 18b. This improves the sealing of the fuel cell stack 1. As can be seen in FIGS. 5 and 6, the insulation 14 is provided with a flange 36 which acts as interface for the clamping element 28. The clamping element 28 may be a screw or bolt. The clamping element 28 is arranged such that a part of an edge of the insulation plate 14 is clamped down. This ensures that the seal between the insulation plate 14 and the end plate 4 is maintained even if a compression of the fuel cell stack 1 becomes loose, for example due to wear and/or breakage.

As describes above, both the sealing element 18a, 18b and the third sealing element 24 are provided at a surface that is perpendicular to the stacking direction such that each of the sealing elements 18, 24 is compressed in the stacking direction both during assembly and in its assembled state. This has the advantage that there is no need for a precise positioning of the sealing elements to ensure a sufficient seal of the fuel cell stack 1.

### REFERENCE NUMERALS

1 fuel cell stack
2 fuel cell stack body
3 terminal plate
4 end plate
6 power output terminal
8 end plate
10 inlet opening
12 outlet opening
14 insulation plate
15 inlet duct
16 projection
17 outlet duct
18a, 18b first sealing element
20a, 20b groove
22 additional groove
24 second sealing element
26 flange
28 clamping element
30 fastening interface
32 insulation plate
34 housing
36 flange

1. Fuel cell stack comprising at least
a fuel cell stack body with a plurality of unit fuel cells, wherein each unit fuel cell comprises a bipolar plate and a membrane electrode assembly, which are alternatingly stacked in a stacking direction,
a first and second terminal plate sandwiching the fuel cell stack body, wherein the first and second terminal plate are adapted to collect the electric energy generated by the fuel cell stack body,
a first insulation plate and a second insulation plate sandwiching the terminal plates, wherein the insulation plates are adapted to electrically insulate the terminal plates, and a first and second end plate sandwiching the insulation plates,
wherein at least one first sealing element is arranged between at least one insulation plate and the adjacent end plate.

2. Fuel cell stack according to claim 1, wherein the at least one first sealing element is arranged such that an ingression of a fluid in a space between the at least one insulation plate and the adjacent end plate from an outside of the fuel cell stack is prevented.

3. Fuel cell stack according to claim 1, wherein at least one end plate comprises at least one inlet opening and/or at least one outlet opening for supplying reactant and/or coolant to and/or from the fuel cell body, wherein the at least one first sealing element extents around a perimeter of the at least one inlet opening and/or at least one outlet opening.

4. Fuel cell stack according to claim 3, wherein at least one of the insulation plates comprises fuel, oxidant, and coolant inlet ducts, and fuel, oxidant, and coolant outlet ducts, wherein the inlet ducts extend into one inlet opening and/or the outlet ducts extend into one outlet opening, and/or wherein the at least one end plate comprises an opening for each of the inlet ducts and/or outlet ducts of the insulation plate, wherein the inlet ducts and the outlet ducts extend into the respective openings, and wherein each opening is surrounded by a first sealing element.

5. Fuel cell stack according to claim 1 any one of the previous claims, wherein the fuel cell stack further comprises a housing, wherein the housing includes at least a bottom plate and a stack enclosure configured to cover the side faces of the fuel cell stack.

6. Fuel cell stack according to claim 5, wherein at least one second sealing element is arranged between the housing and at least one of the end plates.

7. Fuel cell stack according to claim 5, wherein one of the end plates is further configured as the bottom plate of the housing.

8. Fuel cell stack according to claim 1, wherein at least one of the end plates is provided with at least one flange, wherein the flange extends around a perimeter of the end plate.

9. Fuel cell stack according to claim 1, wherein the at least one first sealing element is arranged at a surface of the at least one end plate facing the associated insulation plate and/or at a surface of the at least one insulation plate facing the end plate.

10. Fuel cell stack according to claim 1, wherein the at least first and/or second sealing element is fixed to the at least one end plate or the at least one insulation plate.

11. Fuel cell stack according to claim 10, wherein the at least one first and/second sealing element is arranged in a groove, is adhesively bonded, or injection molded.

12. Fuel cell stack according to claim 1, wherein the at least one first and/or second sealing element is a gasket or an O-ring.

13. Fuel cell stack according to claim 1, wherein the at least one first and/or second sealing element is an elastomeric element that is compressed in the stacking direction.

14. Fuel cell stack according to claim 13, wherein the at least one first sealing element is compressed by weight and/or by at least one compression element configured to provide an additional compression force on the fuel cell stack.

15. Fuel cell stack according to claim 1, wherein the fuel cell stack includes at least one clamping element configured to apply additional force on the at least one insulation plate such that the at least one first sealing element is further compressed in the stacking direction.
